(19) United States
(12) Patent Application Publication
(10) Pub. No.: US 2026/0326521 A1
(43) Pub. Date: Oct. 22, 2026

(54) TRUCK BED CAP

(71) Applicant: Wen SHI, Shenzhen (CN)

(72) Inventor: Wen SHI, Shenzhen (CN)

(21) Appl. No.: 19/711,778

(22) Filed: Jun. 17, 2026

(30) Foreign Application Priority Data
Jun. 3, 2026 (CN) 202620817534.1

(51) Int. Cl. B60J 7/16

(52) U.S. Cl. CPC B60J 7/1607

(57) ABSTRACT

A truck bed cap for covering a truck bed, including: a top cover assembly, a left side wall assembly, a right side wall assembly, a rear side wall assembly and a front side wall assembly. Each side wall assembly has an upper portion connected to respective edge of the top cover assembly and a gull-wing door configured to flip upward. The left and right sides of the front side wall assembly are connected to the left side wall assembly and the right side wall assembly, respectively. Each side wall assembly is connected to each other by fasteners.

### TECHNICAL FIELD

The present disclosure relates to the technical field of truck accessories, in particular to a truck bed cap.

### CROSS REFERENCE TO RELATED APPLICATION

This application claims priority to Chinese Patent Application No. 202620817534.1, filed on Jun. 3, 2026 in the China National Intellectual Property Administration, the entire disclosure of which is hereby incorporated by reference.

### BACKGROUND

With the rapid development of the pickup truck market, truck bed caps (commonly known as “bed covers” or “tonneau covers”) are widely used to meet requirements for cargo waterproofing, anti-theft protection, and aesthetic appearance. Currently, truck bed caps available on the market mainly include integral flip-up type, three-fold type, roll-up type, and two-side flip-up type, among others.

However, existing bed covers suffer from numerous inconveniences during use. First, integral flip-up or roll-up bed covers can only be opened from the rear of the cargo bed. When the pickup truck is parked against a wall or there are obstacles at the rear, the user cannot access or retrieve goods from the side and must move the vehicle or entirely remove the bed cover, resulting in extremely cumbersome operation. Second, although some two-side flip-up bed covers enable lateral opening, the rear portion remains closed, resulting in insufficient flexibility when goods need to be loaded or unloaded from the rear. Furthermore, existing side-openable bed covers often have complex structures with unreasonable layouts of hinges and gas struts, leading to laborious opening, sagging of the gull-wing doors, and susceptibility to deformation after prolonged use.

### SUMMARY

In order to overcome the deficiencies of the prior art, the present disclosure provides a truck bed cap which has a simple structure and is provided with a left gull-wing door, a right gull-wing door, and a rear gull-wing door that can be flipped upward, thereby enabling the user to independently open and access the cargo bed from the left, right, and rear directions of the cargo bed. This improves the flexibility and convenience of using the pickup truck bed and further enhances the user experience.

To realize the above objective, the present disclosure provides a truck bed cap for covering a truck bed, including: a top cover assembly;
a left side wall assembly having an upper portion connected to a left edge of the top cover assembly and a left gull-wing door configured to flip upward; a right side wall assembly having an upper portion connected to a right edge of the top cover assembly and a right gull-wing door configured to flip upward; a rear side wall assembly having an upper portion connected to a rear edge of the top cover assembly and a rear gull-wing door configured to flip upward, wherein left and right sides of the rear side wall assembly are connected to the left side wall assembly and the right side wall assembly, respectively; a front side wall assembly having an upper portion connected to a front edge of the top cover assembly, wherein left and right sides of the front side wall assembly are connected to the left side wall assembly and the right side wall assembly, respectively.

The beneficial effects of the present disclosure are as follows: through the arrangement of the above structure, when in use, the left gull-wing door, the right gull-wing door, and the rear gull-wing door can each be independently flipped upward to open. This allows the user to directly access and retrieve goods from the left, right, and rear directions of the truck bed without needing to remove the entire bed cover. Even when the truck is parked against a wall or obstacles are present at the rear, the user can still open the corresponding gull-wing door from the left or right side to access items quickly, thereby avoiding the need to move the vehicle or take a detour.

The upper portion of the left side wall assembly is connected to the left edge of the top cover assembly, the upper portion of the right side wall assembly is connected to the right edge of the top cover assembly, the upper portion of the rear side wall assembly is connected to the rear edge of the top cover assembly and to the left and right side wall assemblies on both sides, and the upper portion of the front side wall assembly is connected to the front edge of the top cover assembly and to the left and right side wall assemblies on both sides. This configuration forms a stable five-sided enclosed rigid structure. The structure maintains the overall strength of the bed cover while enabling flexible access from the left, right, and rear directions, and effectively resists driving wind pressure and cargo impact.

Thus, on the basis of retaining the basic functions of rain protection and anti-theft for the bed cover, the present disclosure achieves the synergistic effect of independent left, right, and rear three-directional access together with structural stability, thereby enhancing the convenience and adaptability of the truck bed in multiple scenarios.

### BRIEF DESCRIPTION OF DRAWINGS

To more clearly illustrate the technical solutions of the embodiments of the present disclosure, the following briefly introduces the accompanying drawings required for describing the embodiments. The drawings in the following description are merely some embodiments of the present disclosure. Those of ordinary skill in the art may obtain other drawings based on these drawings without creative effort.

FIG. 1 is a schematic structural diagram from a first angle of a truck bed cap of the present disclosure when each gull-wing door is in a closed state;

FIG. 2 is a schematic structural diagram from a second angle of the truck bed cap of the present disclosure when each gull-wing door is in a closed state;

FIG. 3 is an exploded view from a first angle of the truck bed cap of the present disclosure when each gull-wing door is in a closed state;

FIG. 4 is an exploded view from a second angle of the truck bed cap of the present disclosure when each gull-wing door is in a closed state;

FIG. 5 is an exploded view from a first angle of the top cover assembly of the truck bed cap of the present disclosure;

FIG. 6 is an exploded view from a second angle of the top cover assembly of the truck bed cap of the present disclosure;

FIG. 7 is a schematic structural diagram of the truck bed cap of the present disclosure when each gull-wing door is in an opened state;

FIG. 8 is a schematic structural diagram of the truck bed cap of the present disclosure when each gull-wing door is in a closed state and installed on a pickup truck bed;

FIG. 9 is a schematic structural diagram of the truck bed cap of the present disclosure when each gull-wing door is in an opened state and installed on a pickup truck bed;

FIG. 10 is an enlarged view of circle A in FIG. 2;

FIG. 11 is an enlarged view of circle B in FIG. 3;

FIG. 12 is an enlarged view of circle C in FIG. 5.

Description of the reference numerals:

100, top cover assembly; 200, left side wall assembly; 300, right side wall assembly; 400, rear side wall assembly; 500, front side wall assembly; 600, fastener, 110, front top cover; 111, first connecting portion; 120, rear top cover; 121, second connecting portion; 130, front top cover cross beam; 140, rear top cover cross beam; 150, top cover guide rail; 210, left gull-wing door; 220, left hinge; 230, left gas strut; 240, left locking mechanism; 310, right gull-wing door; 320, right hinge; 330, right gas strut; 340, right locking mechanism; 410, rear gull-wing door; 420, rear hinge; 430, rear gas strut; 440, rear locking mechanism.

### DETAILED DESCRIPTION OF THE EMBODIMENTS

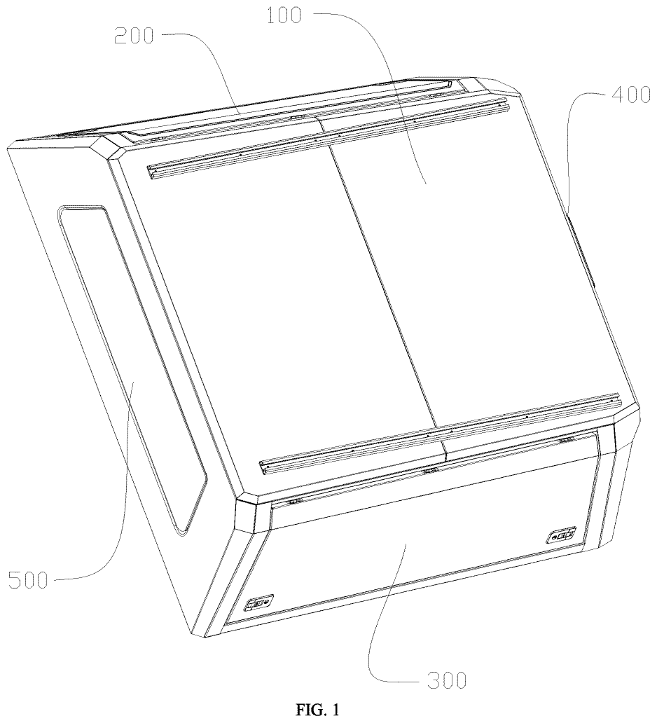

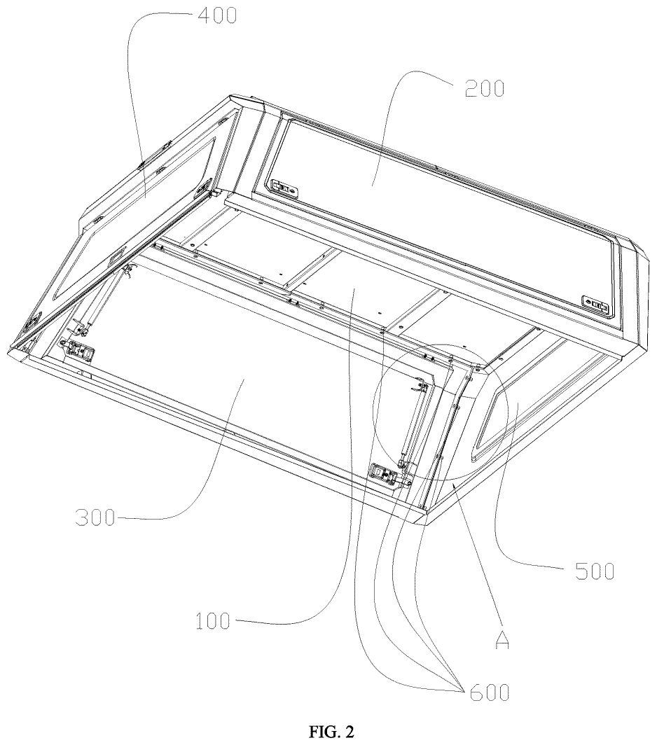

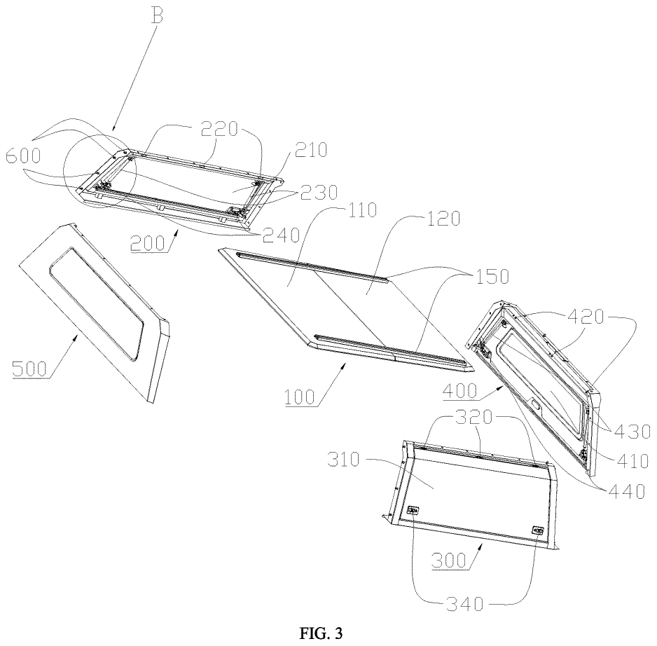

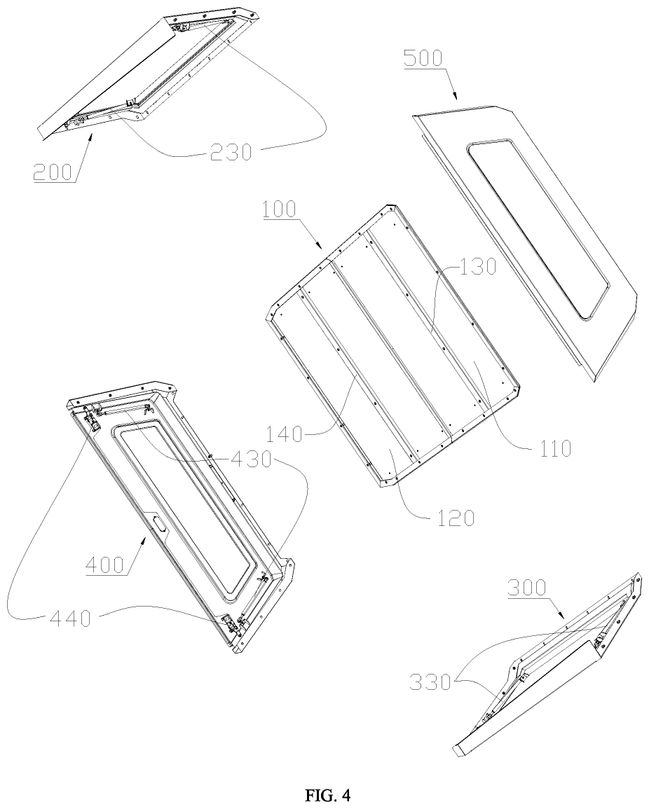

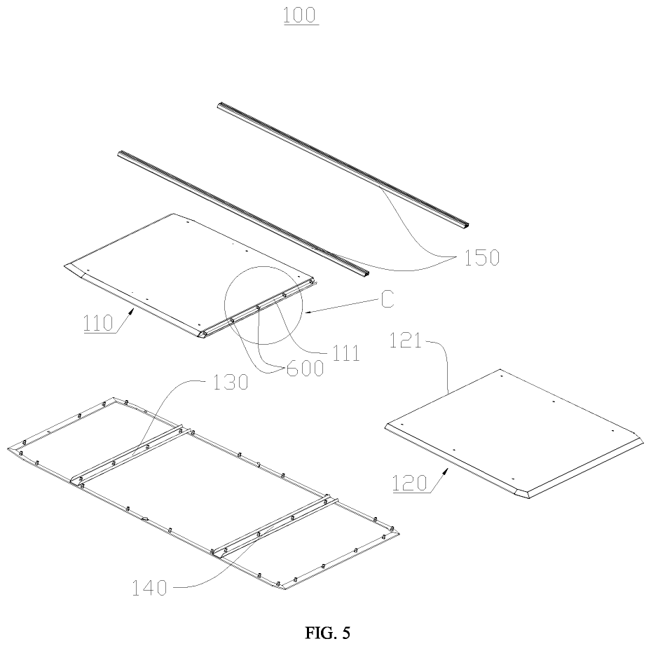

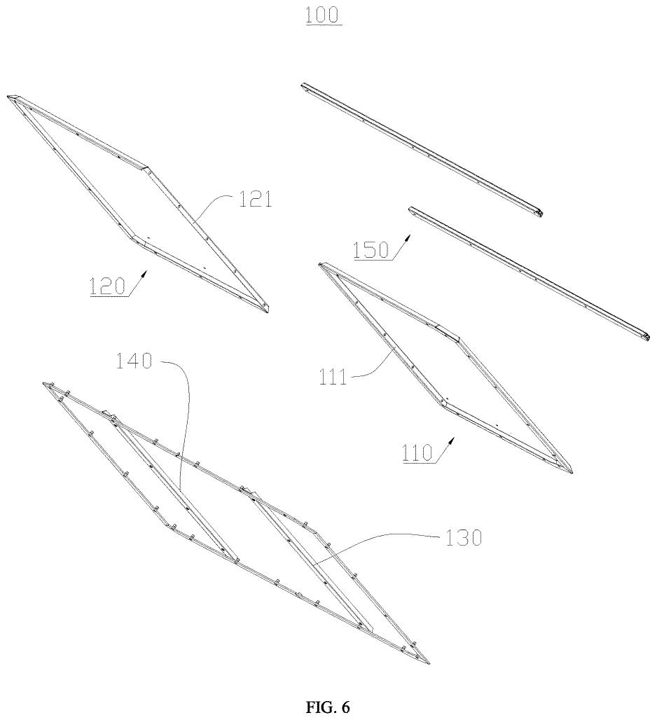

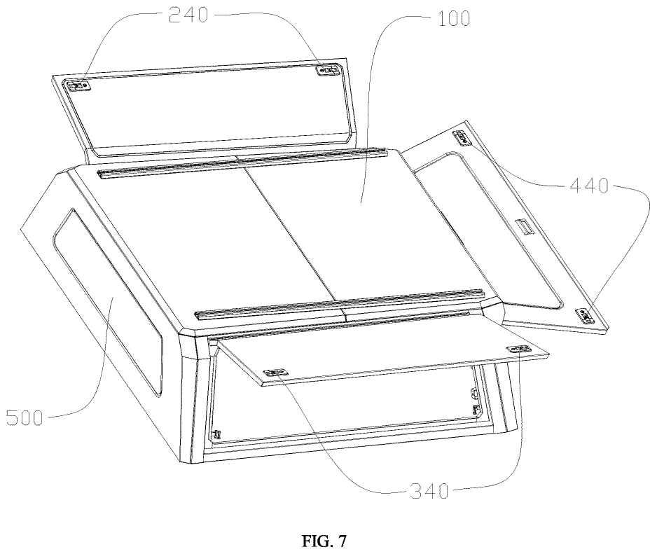

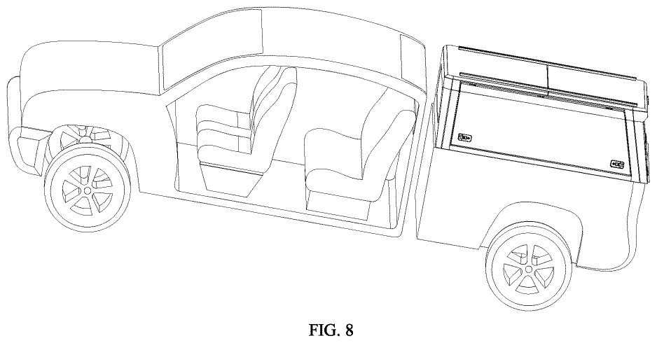

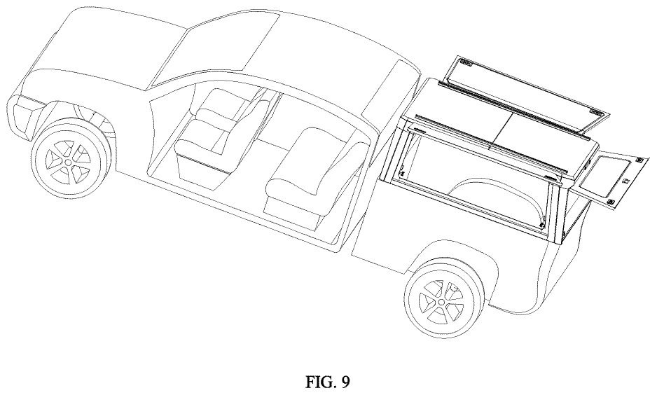

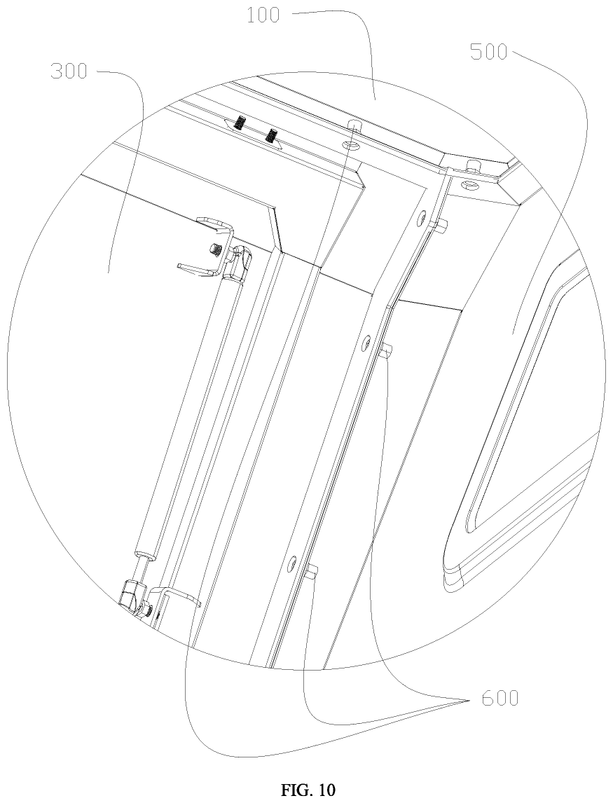

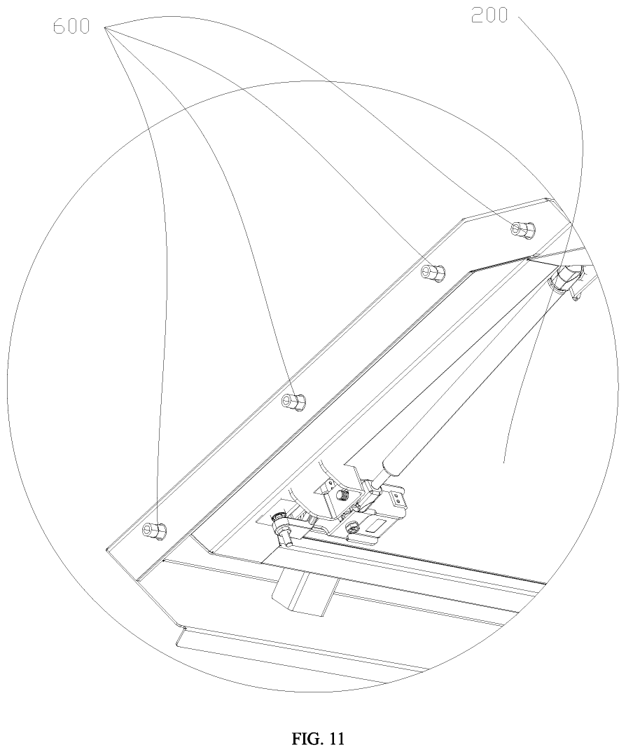

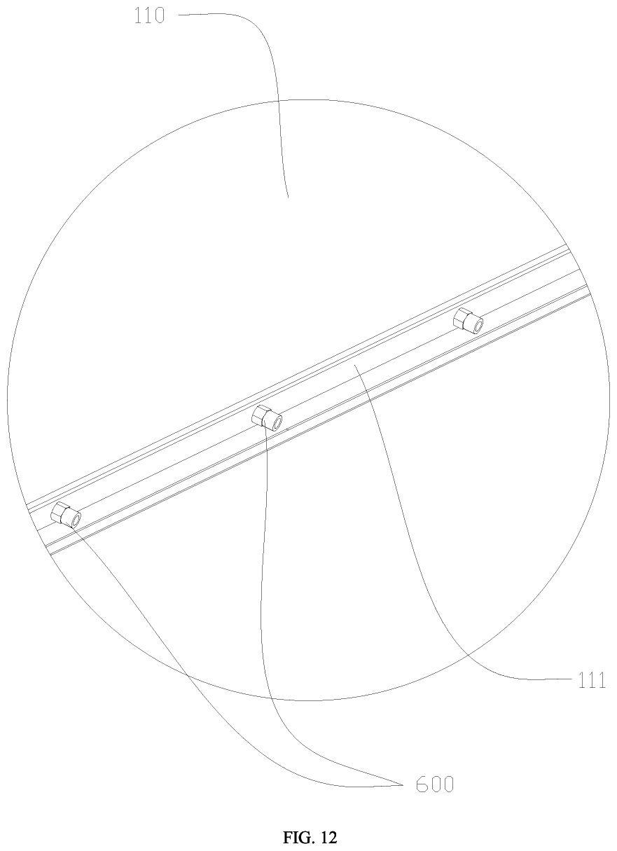

Referring to FIGS. 1 to 12, a truck bed cap for covering a pickup truck bed, including: a top cover assembly 100, a left side wall assembly 200, a right side wall assembly 300, a rear side wall assembly 400, and a front side wall assembly 500. An upper portion of the left side wall assembly 200 is connected to a left edge of the top cover assembly 100, and the left side wall assembly 200 includes a left gull-wing door 210 that is upwardly flippable. An upper portion of the right side wall assembly 300 is connected to a right edge of the top cover assembly 100, and the right side wall assembly 300 comprises a right gull-wing door 310 that is upwardly flippable. An upper portion of the rear side wall assembly 400 is connected to a rear edge of the top cover assembly 100, both lateral sides of the rear side wall assembly 400 are respectively connected to the left side wall assembly 200 and the right side wall assembly 300, and the rear side wall assembly 400 comprises a rear gull-wing door 410 that is upwardly flippable. An upper portion of the front side wall assembly 500 is connected to a front edge of the top cover assembly 100, and both lateral sides of the front side wall assembly 500 are respectively connected to the left side wall assembly 200 and the right side wall assembly 300.

Through the arrangement of the above structure, in use, the left gull-wing door 210, the right gull-wing door 310, and the rear gull-wing door 410 can each be independently flipped upward to open. Thereby enabling a user to directly access and retrieve or place cargo from the left, right, and rear directions of the truck bed without needing to remove the entire bed cover. This three-directional independent opening operation mode effectively shortens loading and unloading time, and is particularly suitable for scenarios where the truck is parked against a wall, there are obstacles behind the vehicle, or the parking space is narrow and maneuvering around the vehicle is inconvenient. Compared with conventional one-piece bed covers that only allow access from the rear, the convenience of use is significantly improved.

With the top cover assembly 100 serving as a base, the upper portion of the left side wall assembly 200 is connected to the left edge of the top cover assembly 100, the upper portion of the right side wall assembly 300 is connected to the right edge of the top cover assembly 100, the upper portion of the rear side wall assembly 400 is connected to the rear edge of the top cover assembly 100. The left and right sides of the rear side wall assembly 400 are respectively connected to the left side wall assembly 200 and the right side wall assembly 300. The upper portion of the front side wall assembly 500 is connected to the front edge of the top cover assembly 100. The left and right sides of the front side wall assembly 500 are respectively connected to the left side wall assembly 200 and the right side wall assembly 300. Thus, the each side wall assembly is mutually positioned and cooperatively supported through multi-point connections at the upper and lateral portions, forming a stable five-sided enclosed box structure that can effectively resist wind pressure and cargo impact during driving while providing excellent rainproof and dustproof performance.

The left gull-wing door 210, the right gull-wing door 310, and the rear gull-wing door 410 all adopt an upward flipping opening manner. Such that after opening, the gull-wing doors are located above or laterally above the top cover assembly 100 and do not additionally occupy the horizontal space on the left, right, or rear sides of the cargo bed. Compared with sliding doors or outward-swinging doors, the upward flipping structure avoids the problem of the gull-wing doors extending outward and interfering with adjacent vehicles or obstacles, making it especially suitable for parallel parking spaces, garages, or narrow urban road environments. The user may, according to actual needs, choose to open one, two, or all three gull-wing doors; for example, only the left gull-wing door 210 may be opened to access and retrieve small items. This modular, multi-degree-of-freedom opening combination mode further enhances the flexibility of use of the truck bed. The front side wall assembly 500 is connected to the front edge of the top cover assembly 100 and to the left and right side wall assemblies, thereby forming a complete enclosed front enclosure.

In summary, the present disclosure, through the independent upward flipping design of the left gull-wing door 210, the right gull-wing door 310, and the rear gull-wing door 410, together with the multi-point connection layout among the respective wall assemblies, achieve the synergistic effect of flexible three-directional (left, right, and rear) access and structural stability, thereby significantly improving the convenience and adaptability of the truck bed cap in multiple usage scenarios.

In this embodiment, the top cover assembly 100, the left side wall assembly 200, the right side wall assembly 300, the rear side wall assembly 400, and the front side wall assembly 500 are mutually fixedly connected by fasteners 600. Through the fasteners 600, a reliable detachable mechanical connection is formed between the various side wall assemblies, which not only ensures the structural integrity of the overall bed cover under driving vibration, wind pressure, and cargo impact, but also allows the user to independently replace or repair individual wall assemblies according to actual needs. For example, when a gull-wing door on a certain side experience wear or damage due to long-term use, only the fasteners on the corresponding wall assembly need to be disassembled to achieve localized replacement, without the need to scrap the entire bed cover, thereby effectively reducing maintenance costs.

At the same time, the fastener connection manner enables each side wall assembly to be independently manufactured, painted, and transported, and then quickly assembled into a complete truck bed cap at the user site by means of bolts or screws. Compared with integrally formed or welded structures, this significantly reduces the difficulty of production and logistics, and is particularly suitable for modular customization scenarios (such as selecting side wall assemblies of different widths according to different cargo bed sizes of trucks).

In addition, the preload force of the fasteners 600 is adjustable, allowing the user or installation personnel to appropriately adjust the connection tightness according to actual operating conditions, thereby preventing loosening caused by thermal expansion and contraction or long-term loading, and further improving the long-term service reliability of the bed cover. Through the above fastener connection design, the present disclosure, while realizing the left, right, and rear three-directional independent opening function, also takes into account the requirements of modular manufacturing, convenient maintenance, and flexible adaptation, thereby effectively enhancing the practicality and economy of the product.

In this embodiment, the top cover assembly 100 includes a front top cover 110 and a rear top cover 120, the front top cover 110 and the rear top cover 120 are fixedly connected by fasteners 600. The front top cover 110 is provided with a first connecting portion 111, the rear top cover 120 is provided with a second connecting portion 121. The first connecting portion 111 and the second connecting portion 121 are brought into abutment and then fixedly connected to each other by fasteners 600.

By designing the top cover assembly 100 as a split structure in which the front top cover 110 and the rear top cover 120 are connected, on the one hand, the two top covers can be independently manufactured, painted, and packaged, thereby reducing the complexity and manufacturing cost of individual molds; especially for trucks with longer cargo beds, the split structure can avoid difficulties in injection molding or stamping caused by an excessively long one-piece top cover. On the other hand, the split design enables the truck bed cap to flexibly adapt to truck models with different wheelbases or cargo bed lengths—modular expansion can be achieved by merely adjusting the longitudinal dimensions of the front top cover 110 or the rear top cover 120, without the need to redesign the entire top cover assembly.

The first connecting portion 111 and the second connecting portion 121 are brought into abutment and then fixedly connected by fasteners 600. This “abutment+fastening” combination ensures tight fitting of the contact surfaces at the joint between the front top cover 110 and the rear top cover 120, effectively transmits loads, and avoids warping or relative rotation that may occur with a single fastener connection. At the same time, the abutment structure provides a clear assembly positioning reference, allowing installation personnel to quickly align the two top covers without the aid of complex measuring tools and then lock them with fasteners 600, thereby greatly improving on-site assembly efficiency and connection accuracy. In addition, when one top cover is accidentally damaged, only the damaged portion needs to be replaced individually, without scrapping the entire top cover assembly, further reducing user maintenance costs.

Through the above split top cover and abutment connection design, while ensuring the overall strength and sealing performance of the top of the bed cover, significantly improves manufacturability, vehicle model adaptability, and repair convenience.

In this embodiment, the left side wall assembly 200 further includes left hinges 220, the right side wall assembly 300 further includes right hinges 320, and the rear side wall assembly 400 further includes rear hinges 420. The left gull-wing door 210 is pivotably connected to the left side wall assembly 200 via the left hinges 220, the right gull-wing door 310 is pivotably connected to the right side wall assembly 300 via the right hinges 320, and the rear gull-wing door 410 is pivotably connected to the rear side wall assembly 400 via the rear hinges 420. The left hinges 220, the right hinges 320, and the rear hinges 420 are respectively disposed at the upper edges of the corresponding gull-wing doors. The number of the left hinges 220, the right hinges 320, and the rear hinges 420 is at least two, respectively arranged on both sides of the upper edge of the corresponding gull-wing door. Specifically, at least two left hinges 220 are provided and evenly spaced along the upper edge of the left gull-wing door 210; at least two right hinges 320 are provided and evenly spaced along the upper edge of the right gull-wing door 310; and at least two rear hinges 420 are provided and evenly spaced along the upper edge of the rear gull-wing door 410.

Through the above hinge layout, each gull-wing door flips upward around the hinge axis at its upper edge to open, such that after opening, the gull-wing doors are naturally located above or laterally above the top cover assembly 100 and does not occupy the horizontal external space on the left, right, or rear sides of the cargo bed. Thereby avoiding interference between sliding doors or outward-swinging doors and adjacent vehicles, walls, or obstacles when opened. Arranging two hinges respectively on both sides of the upper edge of the corresponding gull-wing door can provide stable two-point support, ensuring even stress distribution on the gull-wing doors during the flipping process and avoiding deflection or jamming of the gull-wing doors that may be caused by a single-point hinge.

At the same time, the layout of double-sided hinges on the upper edge maximizes the connection span between the gull-wing doors and the corresponding side wall assemblies, effectively distributing the self-weight of the gull-wing doors and the impact loads during opening/closing; thus, each gull-wing door is less prone to sagging or hinge loosening after long-term use. Compared with solutions in which hinges are arranged on the side edges or lower edges, the upper-edge hinges utilize gravity to assist door closing, allowing the user to close any of the gull-wing doors with only a small downward pulling force, and each gull-wing door will not fall by itself after opening, thereby improving operational safety.

Through the above hinge configuration, while realizing the three-directional independent opening function, ensures the smoothness, durability, and spatial adaptability of movement of the gull-wing doors, thereby further optimizing the user experience.

In one embodiment, the number of the left hinges 220, the right hinges 320, and the rear hinges 420 is three each. in addition to one hinge provided on each of the two sides of the upper edge of the corresponding gull-wing door, one hinge is also respectively provided in the middle of the upper edge of the corresponding gull-wing door.

In this embodiment, the left side wall assembly 200 further includes left gas struts 230, the right side wall assembly 300 further includes right gas struts 330, and the rear side wall assembly 400 further includes rear gas struts 430, which are respectively configured to assist in the opening and provide support for the corresponding gull-wing doors. The number of the left gas struts 230, the right gas struts 330, and the rear gas struts 430 is two for each, respectively disposed on left and right sides of the corresponding gull-wing door. Specifically, two left gas struts 230 are provided, one on each side of the left gull-wing door; two right gas struts 330 are provided, one on each side of the right gull-wing door; two rear gas struts 430 are provided, one on each side of the rear gull-wing door.

Through the arrangement of the aforementioned gas struts, each gull-wing door obtains assistance during its opening process, such that the user only needs to apply a relatively small upward pushing force to easily lift each gull-wing door. Particularly for gull-wing doors of larger size or greater weight, the gas struts are capable of balancing the majority of the self-weight of the gull-wing doors, thereby significantly reducing the operating force and enhancing the portability and convenience of daily use. Each gull-wing door is equipped with two corresponding gas struts, respectively located on left and right sides of the gull-wing doors, so that the gull-wing doors are subjected to symmetrical force distribution and achieve smooth motion during both opening and closing processes. This arrangement avoids eccentric loading or twisting of the gull-wing doors that might be caused by a single gas strut, while simultaneously providing redundant support: even if one gas strut fails, the other gas strut can still maintain the basic auxiliary supporting function, thereby preventing safety accidents caused by the sudden dropping of the gull-wing doors.

When the gull-wing doors are opened to any angle, the damping characteristics of the gas struts enable the gull-wing doors to remain stationary at the current position, thereby realizing multi-angle hovering without the need for additional locking devices. This allows the user's hands to be freed when accessing or placing cargo, resulting in more convenient operation. When closing the gull-wing doors, the corresponding gas struts provide controllable damping force to slow down the descending speed of the gull-wing doors, thereby avoiding substantial noise or damage to the hinges and sealing members that would otherwise be generated by gravity-accelerated impact against the wall assemblies. When the vehicle is parked on a slope or encounters strong wind, the continuous supporting force of the gas struts can resist additional external force disturbances, preventing the corresponding gull-wing doors from accidentally closing and thereby injuring the user or damaging the cargo.

Through the bilateral gas struts layout described above, the present disclosure, while preserving the structural advantages of the upward-flipping gull-wing doors, achieve multiple effects including light-force opening, hovering at arbitrary angles, damped closing, and safe anti-drop protection, thereby further enhancing the user's experience.

In this embodiment, the left side wall assembly 200 further includes left locking mechanisms 240, the right side wall assembly 300 further includes right locking mechanisms 340, and the rear side wall assembly 400 further includes rear locking mechanisms 440, which are respectively configured to lock the respective gull-wing doors in the closed position. The number of the left locking mechanisms 240, the right locking mechanisms 340, and the rear locking mechanisms 440 is two for each, respectively disposed on both sides of the corresponding gull-wing door. Specifically, two left locking mechanisms are provided (240), one on each side of the left gull-wing door; two right locking mechanisms are provided, one on each side of the right gull-wing door; two rear locking mechanisms are provided, one on each side of the rear gull-wing door.

Through the arrangement of the aforementioned locking mechanisms, when each gull-wing door is closed, the locking mechanisms securely lock the gull-wing doors to the side wall assemblies or adjacent structures, effectively preventing the gull-wing doors from accidentally springing upward due to vibration, jolting, or crosswind during vehicle travel, thereby ensuring driving safety and cargo anti-theft protection. Each gull-wing door is equipped with two locking mechanisms, respectively located on left and right sides of the gull-wing doors, so that the gull-wing doors experience balanced left-right force distribution when locked. This ensures uniform circumferential compression of the sealing strips, avoiding gull-wing doors warping or insufficient sealing that might result from single-side locking, and thereby improving the rainproof and dustproof performance of the truck bed cap. The bilateral locking design further provides redundancy for safety: even if the locking mechanism on one side fails, the other side can still maintain the basic locking function, preventing the gull-wing doors from suddenly opening during high-speed travel.

When the user unlocks the door, it is only necessary to operate the locking mechanism on either side (for example, through a linkage handle or pull cable to realize synchronous unlocking on both sides), thereby enabling easy opening of the gull-wing doors with convenient operation. The locking mechanisms may adopt various forms such as mechanical snap locks, bolt locks, or handle-equipped latches to meet different users'requirements for anti-theft levels and operating habits. When the vehicle is parked for a long time or travels on bumpy roads, the bilateral locking mechanisms can integrate the gull-wing doors with the wall assemblies into a single unit, jointly resisting torsional loads, reducing additional stress on the hinges and gas struts, and extending the service life of the moving parts.

Through the bilateral locking mechanism layout described above, the present disclosure ensures safe locking, uniform sealing, and structural durability in the closed state while realizing convenient opening of the gull-wing doors, thereby further enhancing the practicality and reliability of the truck bed cap.

In this embodiment, the top cover assembly 100 further includes a front top cover cross beam 130 and a rear top cover cross beam 140. The front top cover cross beam 130 is fixedly connected to the front top cover 110, and the rear top cover cross beam 140 is fixedly connected to the rear top cover 120. The front top cover cross beam 130 and the front top cover 110 are fixedly connected by fasteners 600, and the rear top cover cross beam 140 and the rear top cover 120 are fixedly connected by fasteners 600.

By providing the front top cover cross beam 130 and the rear top cover cross beam 140, the overall bending stiffness and torsional strength of the top cover assembly 100 are enhanced. When the vehicle travels on bumpy roads or encounters lateral wind pressure, the top cover assembly, being the largest wind-receiving surface of the bed cover, is prone to vertical vibration or twisting deformation. The addition of the cross beams is equivalent to forming a reinforcing skeleton inside the top cover, which effectively distributes and bears external loads, suppresses deflection of the top cover surface, and thereby protects the cargo underneath from compression or impact. The front top cover cross beam 130 is fixed to the front top cover 110, and the rear top cover cross beam 140 is fixed to the rear top cover 120, both using fastener connections, thereby forming a reliable detachable connection between the cross beams and the top covers. The fastener connection avoids thermal deformation or curing shrinkage that might be caused by welding or adhesive bonding, ensuring the flatness and appearance quality of the top cover surface.

When the front top cover 110 and the rear top cover 120 are abutted and fastened through the first connecting portion 111 and the second connecting portion 121, the front top cover cross beam 130 and the rear top cover cross beam 140 form an approximately continuous transverse support at the joint, further improving the stiffness of the mid-span region of the top cover assembly and preventing abrupt stiffness changes caused by the split connection. In addition, the cross beams also provide additional mounting bases, facilitating the subsequent installation of external accessories such as luggage racks, solar panels, and lighting fixtures without the need to drill holes in the top cover body, thereby avoiding risks of water leakage or stress concentration.

Through the layout of the top cover cross beams described above, the present disclosure effectively improves the structural strength and expandability of the top cover while maintaining the lightweight and modular characteristics of the bed cover, thereby further enhancing the durability and practicality of the product.

In this embodiment, the top cover assembly 100 further includes two top cover rails 150 configured to support installation of external accessories. The two top cover rails 150 are fixedly mounted on a top of the top cover assembly 100. Specifically, the two top cover rails 150 are fixedly mounted on a top of the front top cover 110 and a top of the rear top cover 120, respectively. Alternatively, a portion of the two top cover rails 150 are fixedly connected to the top of the front top cover 110, and another portion of the two top cover rails 150 are fixedly connected to the top of the rear top cover 120.

Through the arrangement of the two top cover rails 150, a standardized mechanical interface is formed on the top of the truck bed cap. Users can conveniently install various external accessories on the rail according to actual needs, such as luggage boxes, tents, bicycle racks, cargo fixing crossbars, sun awnings, or lighting equipment, thereby expanding the functional boundaries of the truck bed so that it serves not only as an enclosed storage space but also as a multifunctional platform for outdoor activities, long-distance travel, or engineering operations. The two top cover rails 150 are fixedly connected to the top of the front top cover 110 and the top of the rear top cover 120, utilizing the connection region and top plane between the split top covers, so that loads can be uniformly transferred to the entire top cover assembly 100 and the underlying side wall structures, avoiding top cover deformation or cracking caused by excessive local stress.

The two top cover rails 150 may adopt standardized T-slots, dovetail slots, or aluminum alloy profiles with mounting holes, compatible with common vehicle accessory mounting bases available on the market, allowing users to achieve quick attachment and detachment of accessories without drilling or modifying the bed cover. When the vehicle travels on bumpy roads, the secure connection between the bilateral rails and the top cover can resist the inertial forces and vibrations of the accessories, ensuring driving safety. In addition, the rail itself can serve as a reinforcing rib for the top cover, further enhancing the bending stiffness at the joint between the front top cover 110 and the rear top cover 120 and strengthening the structural integrity of the top of the bed cover. When no accessories are installed, the slots of the rail can be sealed with decorative sealing strips to maintain a neat appearance of the top cover and prevent accumulation of debris.

Through the design of the top cover rail 150 described above, the present disclosure realizes modular expansion capability for vehicle-mounted accessories while providing basic covering functionality, thereby improving the scenario adaptability of the truck bed cap.

In this embodiment, a clearance gap is provided between the truck bed cap and the rear portion of the truck cab, wherein the clearance gap is greater than 20 millimeters. Through the arrangement of the aforementioned clearance gap, frame torsional and vibrational displacements can be effectively absorbed, interference and collision can be avoided, and the service life of the bed cover and the vehicle body can be extended. At the same time, the clearance gap provides a sufficient ventilation channel, allowing airflow to exit through the clearance gap during travel, thereby reducing negative pressure inside the cargo bed and decreasing the possibility of dust intrusion from the rear. A larger clearance gap also facilitates adjustment allowance during installation, accommodating manufacturing tolerances of different truck models, so that installation can be completed without precise alignment for each vehicle, thereby reducing assembly difficulty and time cost. In addition, the clearance gap greater than 20 millimeters further reserves compression space for sealing strips or buffer rubber pads, allowing users to install flexible sealing members (such as rubber strips) in the clearance gap, thereby further enhancing the universality and reliability of the product.

In this embodiment, the front side wall assembly 500 is fixedly connected to the top cover assembly 100, the left side wall assembly 200, and the right side wall assembly 300 respectively by fasteners 600; the rear side wall assembly 400 is fixedly connected to the top cover assembly 100, the left side wall assembly 200, and the right side wall assembly 300 respectively by fasteners 600; the left side wall assembly 200 is fixedly connected to the top cover assembly 100, the front side wall assembly 500, and the rear side wall assembly 400 respectively by fasteners 600; and the right side wall assembly 300 is fixedly connected to the top cover assembly 100, the front side wall assembly 500, and the rear side wall assembly 400 respectively by fasteners 600.

Through the multi-point connection layout in which each wall assembly is independently fixed to the other three adjacent assemblies by fasteners 600 as described above, the entire truck bed cap forms a relatively closed grid-like rigid structure. Compared with single-point or few-point connections, this “everywhere connected” design enables loads to be uniformly transferred among the top cover and the front, rear, left, and right wall assemblies. External forces in any direction (such as driving wind pressure, lateral cargo impact, or top snow load) are rapidly distributed to all components, avoiding deformation or fracture caused by local stress concentration. At the same time, each set of fasteners 600 can be independently disassembled; when a certain wall assembly is damaged due to an accident or long-term use, only the fasteners 600 associated with that assembly need to be removed to achieve localized replacement, thereby reducing maintenance complexity and cost.

In addition, the multi-point fastener connections allow each wall assembly to be manufactured and painted before final assembly. During transportation, the components can be disassembled into flat parts, effectively saving packaging and logistics space. After delivery, the user can quickly assemble the product by tightening the fasteners 600 according to the pre-positioned holes without requiring professional equipment such as welding or adhesive bonding. The mutual constraints between the connection points can also effectively resist vibrational loosening during vehicle travel, because when any single fastener loosens, the surrounding fasteners 600 can still maintain the relative positions of the components, and the user only needs to perform periodic inspection and tightening.

Through the omnidirectional multi-point fastener connection design described above, the present disclosure realizes the synergistic advantages of modular production, convenient transportation, rapid assembly, and low-cost maintenance while ensuring the overall strength of the five-sided enclosing structure, thereby further enhancing the engineering practicality and economy of the truck bed cap.

The above descriptions provide one or more embodiments in combination with specific content and do not limit the specific implementations of the present disclosure to these descriptions. Any approximations, similarities, or technical derivations or substitutions made based on the methods, structures, or concepts of the present disclosure shall be deemed to fall within the protection scope of the present disclosure.

What is claimed is:

1. A truck bed cap for covering a truck bed, comprising:
a top cover assembly;
a left side wall assembly having an upper portion connected to a left edge of the top cover assembly and a left gull-wing door configured to flip upward;
a right side wall assembly having an upper portion connected to a right edge of the top cover assembly and a right gull-wing door configured to flip upward;
a rear side wall assembly having an upper portion connected to a rear edge of the top cover assembly and a rear gull-wing door configured to flip upward, wherein left and right sides of the rear side wall assembly are connected to the left side wall assembly and the right side wall assembly, respectively;
a front side wall assembly having an upper portion connected to a front edge of the top cover assembly, wherein left and right sides of the front side wall assembly are connected to the left side wall assembly and the right side wall assembly, respectively.

2. The truck bed cap of claim 1, wherein the left side wall assembly, the right side wall assembly, the rear side wall assembly and the front side wall assembly are fixedly connected to respective edges of the top cover assembly by fasteners.

3. The truck bed cap of claim 1, wherein the top cover assembly comprises a front top cover and a rear top cover fixedly connected to each other by fasteners.

4. The truck bed cap of claim 3, wherein the front top cover is provided with a first connecting portion, the rear top cover is provided with a second connecting portion, and the first connecting portion and the second connecting portion are configured to abut and be fixedly connected to each other by the fasteners.

5. The truck bed cap of claim 1, wherein the left side wall assembly further comprises left hinges, the right side wall assembly further comprises right hinges, and the rear side wall assembly further comprises rear hinges;
the left gull-wing door is pivotably connected to the left side wall assembly via the left hinges, the right gull-wing door is pivotably connected to the right side wall assembly via the right hinges, and the rear gull-wing door is pivotably connected to the rear side wall assembly via the rear hinges.

6. The truck bed cap of claim 5, wherein the left hinges are disposed along an upper edge of the left gull-wing door; the right hinges are disposed along an upper edge of the right gull-wing door; and the rear hinges are disposed along an upper edge of the rear gull-wing door.

7. The truck bed cap of claim 6, wherein at least two left hinges are provided and evenly spaced along the upper edge of the left gull-wing door;
at least two right hinges are provided and evenly spaced along the upper edge of the right gull-wing door; and
at least two rear hinges are provided and evenly spaced along the upper edge of the rear gull-wing door.

8. The truck bed cap of claim 5, wherein the left side wall assembly further comprises left gas struts configured to assist in opening and supporting the left gull-wing door;
the right side wall assembly further comprises right gas struts configured to assist in opening and supporting the right gull-wing door; and
the rear side wall assembly further comprises rear gas struts configured to assist in opening and supporting the rear gull-wing door.

9. The truck bed cap of claim 8, wherein two of the left gas struts are provided, one on each side of the left gull-wing door;
two of the right gas struts are provided, one on each side of the right gull-wing door;
two of the rear gas struts are provided, one on each side of the rear gull-wing door.

10. The truck bed cap of claim 1, wherein the left side wall assembly further comprises left locking mechanisms configured to lock the left gull-wing door in a closed position of the left gull-wing door;
the right side wall assembly further comprises right locking mechanisms configured to lock the right gull-wing door in a closed position of the right gull-wing door; and
the rear side wall assembly further comprises rear locking mechanisms configured to lock the rear gull-wing door in a closed position of the rear gull-wing door.

11. The truck bed cap of claim 10, wherein two of the left locking mechanisms are provided, one on each side of the left gull-wing door;
two of the right locking mechanisms are provided, one on each side of the right gull-wing door;
two of the rear locking mechanisms are provided, one on each side of the rear gull-wing door.

12. The truck bed cap of claim 3, wherein the top cover assembly further comprises a front top cover crossbeam and a rear top cover crossbeam, the front top cover crossbeam is fixedly connected to the front top cover, and the rear top cover crossbeam is fixedly connected to the rear top cover.

13. The truck bed cap of claim 12, wherein the front top cover crossbeam is fixedly connected to the front top cover by fasteners, and the rear top cover crossbeam is fixedly connected to the rear top cover by fasteners.

14. The truck bed cap of claim 3, wherein the top cover assembly further comprises two top cover rails configured to support installation of external accessories.

15. The truck bed cap of claim 14, wherein the two top cover rails are fixedly mounted on a top of the top cover assembly.

16. The truck bed cap of claim 1, wherein a clearance gap is provided between the truck bed cap and a rear portion of a truck cab, and the clearance gap is greater than 20 millimeters.

17. The truck bed cap of claim 2, wherein the front side wall assembly is connected to the top cover assembly, the left side wall assembly and the right side wall assembly by the fasteners.

18. The truck bed cap of claim 2, wherein the rear side wall assembly is connected to the top cover assembly, the left side wall assembly and the right side wall assembly by the fasteners.

19. The truck bed cap of claim 2, wherein the left side wall assembly is connected to the top cover assembly, the front side wall assembly and the rear side wall assembly by the fasteners.

20. The truck bed cap of claim 2, wherein the right side wall assembly is connected to the top cover assembly, the front side wall assembly and the rear side wall assembly by fasteners.
